(19) United States
(12) Patent Application Publication
(10) Pub. No.: US 2025/0058402 A1
(43) Pub. Date: Feb. 20, 2025

(54) SPOT-WELDING ELECTRODE CAP

(71) Applicant: PLANSEE COMPOSITE MATERIALS GMBH, Lechbruck am See (DE)

(72) Inventors: Sebastian SEIBOLD, Lechbruck am See (DE); Konstantin PRABITZ, Graz (AT)

(21) Appl. No.: 18/723,557

(22) PCT Filed: Dec. 15, 2022
(86) PCT No.: PCT/EP2022/086062

§ 371 Date: Jun. 24, 2024

(30) Foreign Application Priority Data
Dec. 22, 2021 (AT) GM50259/2021

(51) Int. Cl. B23K 11/11

(52) U.S. Cl. CPC B23K 11/11

(57) ABSTRACT

A spot-welding electrode cap extends along a longitudinal axis and has an end side with a central cap contact surface and with a transition section connecting directly radially and tangentially to the cap contact surface. The transition section is configured to be convexly curved with a radially outwardly continuously increasing curvature.

The present invention relates to a spot-welding electrode cap for resistance spot-welding of galvanized steel sheets.

The trend in car body construction in the automotive industry is increasingly moving towards the use of high-strength steels, such as dual-phase steels, in areas of the car body subject to high mechanical loads. The use of these steels makes it possible to produce more delicate structural components and thus reduce the overall weight of the body. To protect the body from unwanted corrosion, the market offers corresponding high-strength steels in galvanized form.

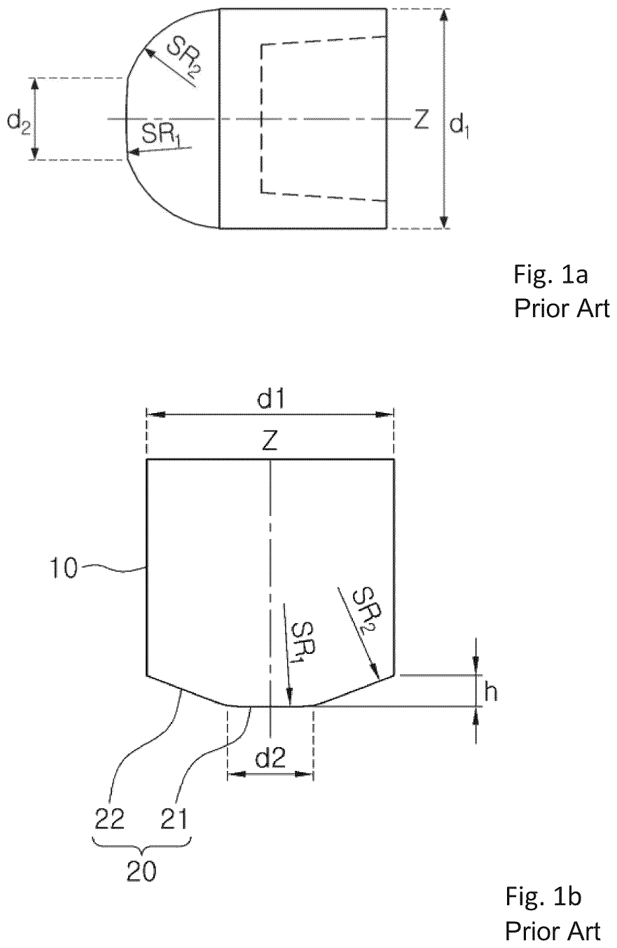

During spot-welding, so-called spot-welding electrode caps are attached to the effective points of a welding gun. The purpose of these caps is to guide the welding current into the joining partners with as little loss as possible, to dissipate the excess heat and to press the joining partners together. These caps are wearing parts that must be replaced at regular intervals. The external shape of the electrode caps is specified in the standard “Resistance welding-Spot-welding electrode caps EN ISO 5821:2009 (D) (DIN EN ISO 5821:2010-04)”. For the use of caps in car body construction, the shape of type F1 has become established-see also FIG. 1a below.

The use of F1 standard geometry for spot-welding body parts causes several problems when welding sheets of the high-strength and galvanized steels described above.

It is known that the phenomenon of liquid metal embrittlement, also known as LME (liquid metal embrittlement), occurs when mechanical stress, liquid zinc and high-strength steels are combined. In this corrosion mechanism, the zinc heated and ultimately melted by the welding process penetrates the grain boundaries of the steel and leads to a reduction in cohesion in this embrittlement reaction. This happens in such a way that, together with the mechanical stress caused by the two welding electrodes pressing against each other and thermally induced stresses, cracks form. In extreme cases, these cracks can lead to immediate failure of the weld spot or significantly reduce the strength of the welded joint, thus reducing the strength advantage of the high-strength primary material used.

In addition to the conditional material combination of steel and zinc, the main factors influencing brittle fracture due to liquid metal embrittlement are the temperature, as an increase in temperature also increases the amount of liquefied zinc and thus the amount of penetrating and reaction-promoting, embrittling metal, and the mechanical load in terms of plastic strain and strain rate.

To keep the liquid metal embrittlement as low as possible, the state of the art attempts, for example, to keep the introduced current as low as possible. This reduces the amount of heat introduced and consequently the amount of liquid zinc available for LME. However, this measure is limited in that the amount of heat introduced must be sufficient to create a permanent bond between the joining partners.

Another way to counteract LME would be to keep the welding gun closed for a certain time after the current has passed (holding time) to dissipate as much heat as possible via the heat transfer to the welding electrodes. However, this has the disadvantage of lengthening the cycle per weld.

KR101988769 B1 attempts to reduce the risk of liquid metal embrittlement by specifically modifying the F1 cap tip geometry. With reference to FIG. 1b below, the modification relates to the selection of the following parameters, wherein an electrode tip section with a cap contact surface which has a diameter d2 with respect to a central axis Z with a spherical radius SR1 of the cap contact surface and an adjoining surface with a spherical radius SR2, with the proviso 24 that SR1 is ≤100 mm, SR2 is >10 mm and the cap tip area comprising SR1 and SR2 is ≤1.5 mm with respect to a height h along the central axis. The electrode cap of KR101988769 B1 therefore exhibits a sudden change in the ball radii at the transition between the surfaces. At this transition, an increased mechanical load occurs at certain points, which still favors the formation of liquid metal embrittlement.

The object of the invention can therefore be seen in providing a welding cap with which the risk of liquid metal embrittlement during spot-welding is further reduced.

This object is solved by a spot-welding electrode cap according to claim 1. Advantageous further embodiments of the invention can be found in the dependent claims, which can be freely combined with one another, in the following description and in the figures.

The spot-welding electrode cap according to the invention extends along a longitudinal axis and has an end face with a central cap contact surface for contacting the surface of a component to be welded and a transition section directly radially and tangentially adjoining the cap contact surface, the transition section being convexly curved with a curvature which increases continuously radially outwards.

It was surprisingly found that by modifying the geometry of the spot-welding electrode cap tip, namely by creating a specially shaped transition section directly radially and tangentially adjacent to the welding cap contact surface, the formation of cracks at welding spots due to liquid metal embrittlement can be greatly reduced or even completely avoided. The modification is based on the fact that, in addition to the temperature factor already mentioned, the plastic deformation and the strain rate in the welded sheets after the interface to the coating have a significant influence on embrittlement during loading. It was therefore expedient to select the outer shape of the electrode in such a way that the elongation rates are kept as low as possible in the LME-critical areas during the compression of the welding gun. The contour of the electrode according to the invention reduces the risk of LME by reducing the plastic strains, reducing the strain rates and reducing the maximum surface temperatures during the welding process. The cap tip shape according to the invention specifically avoids extreme changes in the transition of the contact surface and thus enables a more even distribution of the LME factors pressure and temperature in the welding substrate.

The spot-welding electrode cap of the present invention has the cap contact surface on its end face and a transition section immediately radially and tangentially adjacent to the cap contact surface. The cap contact area is understood to be the area intended for contacting the surface of a component to be welded and is usually referred to as d₂ in the field. To avoid misunderstandings, reference is made to EN ISO 5821:2009 (D) (DIN EN ISO 5821:2010-04), which is incorporated herein by reference in its entirety and the terminology of which is considered valid for the description of the present invention.

As is also known from standardized spot-welding electrode caps, for example the standard caps A0, B0, C0, D0, F1 and G0 from EN ISO 5821:2009 (D) (DIN EN ISO 5821:2010-04), the cap contact surface according to the invention is either not curved, i.e. flat, or in other words with an infinite radius of curvature, or the cap contact surface is curved.

In embodiments of the present invention with a curved cap contact surface, the cap contact surface is preferably convexly curved with a radius of curvature R₁>32 mm, further preferably the cap contact surface is convexly curved with a radius of curvature R₁>50 mm, corresponding to a variant of the F1 standard cap type from EN ISO 5821:2009 (D) (DIN EN ISO 5821:2010-04). In a further embodiment, R₁ is in a range from 50 mm up to and including 100 mm. Further preferred radii of curvature R₁ are given in Table 1, page 5, or Table A.1 pages 9 and 10 of EN ISO 5821:2009 (D) (DIN EN ISO 5821:2010-04).

According to a further embodiment of the present invention, the cap contact surface is convexly curved with a continuously increasing curvature towards the radial outside, i.e. free of abrupt changes in curvature.

In this embodiment, the curvature of the cap contact surface preferably increases linearly towards the radial outside, i.e. the cap contact surface runs along the contour of a clothoid. The term clothoid is known to the skilled person. In a recognized definition, a clothoid is described by a series of increasingly smaller circles (or increasingly larger circles, depending on the direction of view) whose infinitesimally small arc segments merge tangentially into one another.

During the development of the present invention, it has been shown that in the welding process with F1 electrode caps, the transition of the cap contact surface to the typically cylindrical or conical outer surface of the spot-welding electrode cap causes a particularly high strain rate at the outer edge of the welding spot, thus representing a particularly critical point for LME and consequently causing damage due to cracking at the welding spot.

In practice, the skilled person always determines suitable welding ranges for spot-welding electrode caps, comprising the parameters electrode force, current intensity, holding time and modulations of current or force application and removal, for example in accordance with EN ISO 5821:2009 (D) (DIN EN ISO 5821:2010-04) Table 2 page 6.

The minimum welding current is defined, for example, in September 1220-2 (2011) on page 5 in such a way that the minimum spot weld diameter is at least 4√t (t=sheet thickness). This must be ensured for five identical samples. The maximum welding current is defined by the absence of spatter for a sample size of five identical samples. September 1220-2 (2011), for example, provides an overview of suitable welding parameters for the F1 electrode cap on page 18. A welding time of 380 ms, an electrode force of 4.5 kN and a holding time of 300 ms are described as a welding example on page 28.

Within a welding area determined by the skilled person, the cap tip inevitably penetrates slightly into the base material, such as galvanized steel sheets, during the welding process. When the cap tip penetrates the welding substrate, not only the cap contact surface but also part of the transition area on the cap contact surface side between the cap contact surface and the outer surface, hereinafter referred to as the transition section, always contacts the welding substrate at the welding point. In addition to the characteristic welding lens that connects the welded sheets to each other, the spot weld therefore always has an indentation above the welding lens on each sheet side that corresponds to the weld cap tip geometry.

By providing a modified transition section which directly adjoins the cap contact surface radially and tangentially and is convexly curved towards the radial outside with a constantly increasing curvature, the present invention overcomes the problem of the prior art in which the transition between cap contact surface and transition section is always characterized by an abrupt change in the radius of curvature and causes the strongest plastic deformations, greatest expansion rates and most uneven heat dissipation on the sheet metal surfaces.

With a continuous gentle change in curvature according to the invention, the strain rate of the welding substrate when contacting the transition section is considerably reduced. This results in a significant reduction in the formation of cracks on the sheet surface around the electrode indentation caused by LME.

With the course of the transition section according to the invention, not only can the lowest possible strain rate be achieved at the transition from the tip radius, but at the same time the greatest possible distance to the welding substrate can be maintained with increasing distance from the welding substrate contact surface. In this way, a defined welding spot can be guaranteed. At the same time, more uniform and faster cooling takes place on the sheet surface, which results in a smaller amount of liquid zinc being formed.

Surprisingly, it was also found that in order to achieve the lowest possible strain rate at the transition from the tip radius on the one hand, but also to obtain the greatest possible difference with increasing distance from the contacting surface of the welding substrate so that a defined welding spot can be guaranteed, the basic shape of a clothoid is particularly advantageous. According to a further development of the present invention, the curvature in the transition section directly and tangentially adjacent to the cap contact surface therefore increases linearly towards the radial outside, i.e. along the contour of a clothoid.

The following series expansion can be used to calculate the coordinates of a clothoid in a Cartesian coordinate system. This series expansion is an approximation method and is also sufficiently accurate with regard to alternative mathematical calculation methods in the context of practical application:

$${X}_{KI} = L ( 1 - {T}^{2} / 10 + T 4 / 216 - T 6 / 9360 )$$

$${Y}_{KI} = L ( T / 3 - T 3 / 42 + T 5 / 1320 - T 7 / 75600 )$$

L is a control variable that describes the length of the clothoid section. L is defined at the start of the transition section as the start of the clothoid and is therefore 0 mm.

T represents the cutting angle of the tangents at the start and end point of the clothoid section in radians and is calculated using the following formula:

$$T = {L}^{2} / ( 2 * {A}^{2} )$$

A is the parameter of the clothoid and is freely selectable. The selection of A allows the clothoid to be stretched or compressed. Clothoids have the property of being similar to each other, so that the clothoid coordinates X and Y can be scaled to the sensible range apparent to the skilled person via a scaling constant b.

The following formulae give an example of the relationship between the general clothoid coordinates and a cap contact surface or a transition section of the welding electrode according to the invention. The coordinate system for the clothoid coordinates has its origin correspondingly in the center of the welding contact surface or in the transition point of the welding contact surface and transition section in the case of a flat cap contact surface. If there is an initial curvature at the transition, the clothoid coordinate system is shifted accordingly so that the clothoid starts running at the transition section with the curvature of the transition.

X=b*X_{KI}

Y=b*Y_{KI}

L starts with L=0 mm and is increased by 0.01 mm for each additional coordinate pair X_{KI}/Y_{KI}. If, for example, A=1.22 is defined, then b is set at b=9 for a lower limit dimension, as the contact area would be too large for b>9 and therefore a defined welding spot could no longer be guaranteed. For an upper limit dimension, b=3 then applies, as for b<3 there is no sufficient reduction in the strain rate and therefore no significant reduction in the LME risk. Therefore, for A=1.22, b according to the invention is in the range of 3 to 9, preferably 4 to 8, preferably 4.5 to 7.5 and particularly preferably 5 to 6, for example 5.6. It is known to the skilled person that clothoids falling within the said parameter range can also be expressed mathematically in alternative ways.

In embodiments of the invention, the basic shapes of the cap contact surface and the transition section described above can be combined with each other as desired. To avoid abrupt changes in the radius of curvature at the transition, it is self-evident that in the present invention the curvature of the transition portion at the transition between the contact surface and the transition portion begins with the curvature of the cap contact surface at the transition. The following advantageous combinations are listed among the large number of conceivable combinations:

Flat cap contact surface with a transition section that is radially and tangentially directly adjacent to the cap contact surface, whereby the transition section is convexly curved with a curvature that continuously increases radially outwards.

Flat cap contact surface with a transition section directly adjoining the cap contact surface radially and tangentially, the transition section being convexly curved with a curvature that increases linearly towards the radial outside. This embodiment is particularly preferred.

Convexly curved cap contact surface with a constant spherical radius SR1 and a transition section radially and tangentially directly adjoining the cap contact surface, wherein the transition section is convexly curved with a curvature that increases continuously towards the radial outside. The ball radius SR1 is preferably in a range from 32 mm to 100 mm, more preferably in a range from 50 to 100 mm.

Convexly curved cap contact surface with a constant spherical radius SR1 and a transition section radially and tangentially directly adjoining the cap contact surface, wherein the transition section is convexly curved with linearly increasing curvature towards the radial outside. The ball radius SR1 is preferably in a range from 32 mm to 100 mm, more preferably in a range from 50 to 100 mm. This embodiment is particularly preferred.

Cap contact surface with a convex curvature that increases continuously radially outwards and a transition section that directly adjoins the cap contact surface radially and tangentially, wherein the transition section is convexly curved with a curvature that increases continuously radially outwards.

Cap contact surface with a convex curvature that increases linearly towards the radial outside and a transition section that is radially and tangentially directly adjacent to the cap contact surface, the transition section being convexly curved with a curvature that increases continuously towards the radial outside.

Cap contact surface with a convex curvature that increases linearly towards the radial outside and a transition section that directly adjoins the cap contact surface radially and tangentially, wherein the transition section is convexly curved with a curvature that increases linearly towards the radial outside. In this particularly advantageous embodiment, the cap contact surface and the transition section run along the contour of a common clothoid.

Although the caps should always be positioned along a common axis in an ideal welding process, in practice the geometry of the welding guns can result in minimal tilting of the opposing electrode caps. The electrode cap according to the invention with the novel cap tip geometry additionally compensates for this and thus further reduces very localized plastic strains.

Since the improvement according to the invention only concerns the front section of a spot-welding electrode cap, the further shape of the spot-welding electrode cap is basically uncritical. The modification of the cap tip according to the invention can be applied to any conceivable design and dimensions of a spot-welding electrode cap.

The spot-welding electrode cap is preferably rotationally symmetrical with respect to the longitudinal axis. In embodiments, however, it is possible that the cap contact surface is not designed centrally but is positioned offset with respect to the longitudinal axis, as is known, for example, from the DO standard cap type from EN ISO 5821:2009 (D) (DIN EN ISO 5821:2010-04).

The spot-welding electrode cap according to the invention has a diameter d₁. This diameter is basically uncritical as long as the electrode cap is suitable for welding, in particular galvanized steel sheets. Typically, the spot-welding electrode cap according to the invention has a diameter d₁ of at least 5 mm, preferably from 5 to 50 mm, more preferably from 10 to 25 mm and more preferably from 13 to 20 mm.

In practice, when welding two sheets, the electrode indentations corresponding to the cap tip geometry already mentioned are usually found at the welding point, the depth of which relative to the surface of the sheet adjacent to the welding point is referred to below as the height h′. The height is basically dependent on the determined welding area, which, as explained above, in turn depends on the thickness of the welding substrate. With a standard sheet thickness of 1.6 mm, the height h′ per sheet is in the range of approx. 0.1 mm to 0.5 mm. When welding three sheets with a usual thickness of 1.6 mm, h′ can be up to 0.9 mm.

Taking the height h′ into account, the cap tip area comprising the transition section is ≥ a height h′ of the corresponding electrode indentation at the welding point, measured along the longitudinal axis from the outermost point or foremost point of the cap tip. The height h′ describes the distance between the lowest point of the indentation and a plane which is defined by the outer sheet metal surface surrounding the spot weld and not affected by the spot weld, i.e. excluding any shoulders at the edge of the spot weld. h′ can be determined as h′_{Max} (i.e. the indentation with the highest height is decisive) from enlarged images of 5 cross-sections analogous to the following practical test example by the skilled person. h is preferably at least 1.1*h′_{Max} inclusive.

Furthermore, the height h in the present invention is preferably in a range of ≥0.1 mm to 1.5 mm inclusive, more preferably ≥0.2 mm to 1.5 mm inclusive, more preferably ≥0.3 mm to 1.5 mm inclusive, more preferably ≥0.4 mm to 1.5 mm and still more preferably ≥0.5 mm to 1.5 mm inclusive. With regard to the sheet thicknesses and welding ranges commonly used in the automotive industry, h is preferably in a range of ≥0.1 mm to ≥1.0 mm, ≥0.2 mm to ≥1.0 mm, or ≥0.3 mm to ≥1.0 mm. In the event that the cap is used to weld several layers of sheet metal and therefore deeper indentations are to be expected due to the higher force to be applied, the height h can be adjusted accordingly in relation to the height h′.

Taking into account the above requirement with regard to the height h of the cap tip area necessary with regard to the height h′, the skilled person can select the diameter d₂ of the cap contact surface and the extent of the transition section.

The cap contact surface preferably extends with its diameter d₂ over 30 to 80%, preferably over 30 to 65% and more preferably over 35 to 45% of the outer diameter d1 of the spot-welding electrode cap.

According to a further development of the present invention, the transition section extends radially outwards with at least 20% up to and including 70% of the outer diameter d₁ of the welding cap.

The further course of the transition area between the cap contact surface and the jacket of the welding cap after the transition section is basically uncritical.

In any case, the decisive factor for the present invention is that the transition section extends far enough to ensure that, in a defined welding area, the entire edge area of the electrode impression on the welding substrate contacts the transition section or, conversely, that the welding cap does not contact the welding substrate beyond the transition section during contact under normal welding conditions. This ensures that there is a low strain rate at the contact point at the edge area, i.e. a low change in deformation of the substrate as a function of time, and at the same time a sufficient distance to the substrate/welding spot is achieved to guarantee a defined welding spot. At the same time, the plastic elongation, i.e. the permanent deformation after relief by the welding electrodes, is also reduced overall, especially in the event that the caps of the cap pair should be tilted towards each other during the welding process due to the tong geometry. As a result, the material properties and the geometry of the welding points are also much more uniform in the case according to the invention.

Compared to the F1 welding cap, the surface of the contacting edge area of the welding cap according to the invention is larger, so that on the one hand the aforementioned heat dissipation from the welding substrate is increased and has a positive effect on the quality of the welding spot and, in addition, the molten zinc tends to spatter out less.

In the event that the transition area in its entirety between the cap contact surface and the jacket runs along one of the contours described here, the transition section can thus also represent the entire transition area at one extreme. In other words, in such embodiments, the cap tip portion comprising the cap contact surface d₂ and the transition portion comprises a diameter corresponding to the outer diameter d₁. Preferably, the cap tip portion comprising the cap contact surface and the transition portion radially outwardly comprises 100% to 50% of the outer diameter d₁. The possibly remaining part of the transition section begins where the transition section no longer runs along one of its contours defined here as being in accordance with the invention. For example, the transition section ends by transitioning into a constant spherical radius or into a conical surface and accordingly amounts to 0 to 50% in relation to the outer diameter d₁.

The spot-welding electrode cap according to the invention also typically has an inner cone with a diameter d₃ and a length l₃ for fastening and cooling the electrode cap on the electrode shaft. These are essentially uncritical as long as the electrode cap is suitable for attachment to an electrode shaft. Preferably, diameter d₃ is in a range from 10.0 mm (+/−0.1 mm) to 15.0 mm (+/−0.1 mm) and length l₃ is in a range from 8.0 mm (+/−0.1 mm) to 12.0 mm (+/−0.5 mm).

The spot-welding electrode cap according to the invention also has a length l₁. The length l₁ is essentially uncritical as long as the electrode cap is suitable for spot-welding. Typically, the spot-welding electrode cap according to the invention has a length l₁ a range from 18 mm (+/−0.5 mm) to 28 mm (+/−0.5 mm).

Since the industry uses standardized cap types, in further embodiments of the present invention the spot-welding electrode cap, together with the tip geometry modified according to the invention, has the basic shape of an A0, B0, C0, D0, F1 or G0 welding electrode cap according to EN ISO 5821:2009 (D) (DIN EN ISO 5821:2010-04), preferably with the dimensions and tolerances specified therein from Table 1, page 5 and Table A.1, page 9 in conjunction with Table 3, page 6.

According to a preferred further development of the present invention, the spot-welding electrode cap, together with the tip geometry modified according to the invention, has the shape and dimensions of an F1 standard cap according to EN ISO 5821:2009 (D) (DIN EN ISO 5821:2010-04) Table 1, page 5 and Table A.1, page 9 in conjunction with Table 3, page 6.

The spot-welding electrode cap of the present invention typically consists of materials known in the art. Materials suitable for the purposes of the present invention are specified in the standard DIN EN ISO 5182:2016, Table 3, pages 8 and 9. In particular, copper or known copper alloys, especially CuCrZr, should be mentioned here.

Methods for manufacturing welding caps are generally known. For example, the welding cap according to the invention can be produced by machine turning from rods of the material. To check the electrode contour, the profile of the welding cap can be recorded using a coordinate measuring machine and compared with a technical drawing.

In a spot-welding process, the welding caps according to the invention are used in such a way that they are placed on the opposing effective points of a welding gun and the opposing welding caps are placed with their contact surfaces on the opposite sides of a stack of sheets and weld them together within a defined welding area. Due to its advantageous geometry, the spot-welding electrode cap according to the invention is ideally suited for preventing liquid metal embrittlement in a two-sided resistance spot-welding process of galvanized steel sheets.

Further advantages and usefulness of the invention will become apparent from the following description of embodiments with reference to the accompanying figures.

The figures show:

FIG. 1a: a schematic representation of an F1 standard cap;

FIG. 1b: a schematic representation of the welding cap according to KR-101988769 B1;

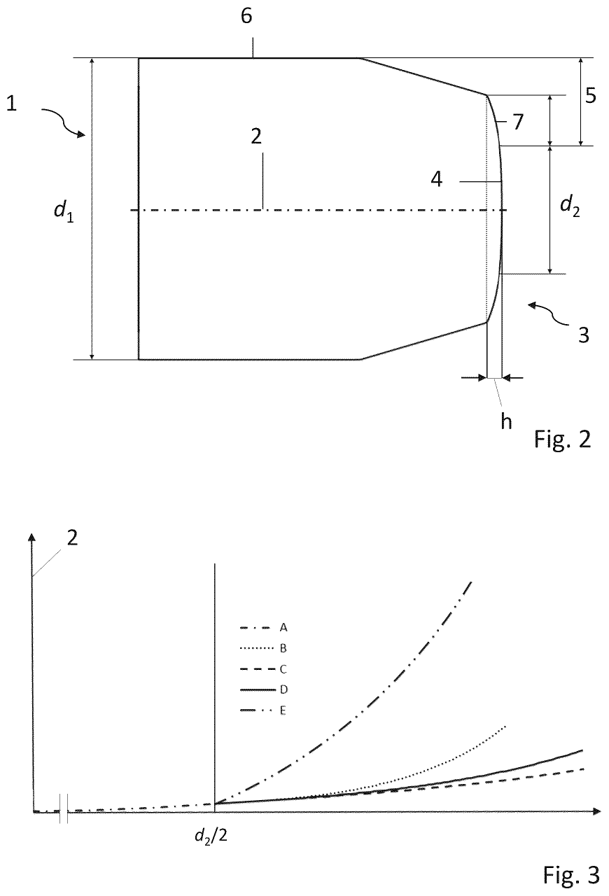

FIG. 2: a schematic representation of a cap according to the present invention

FIG. 3: an enlarged schematic representation of the cap tip area of the cap of the present invention compared to an F1 cap with a curved cap contact surface;

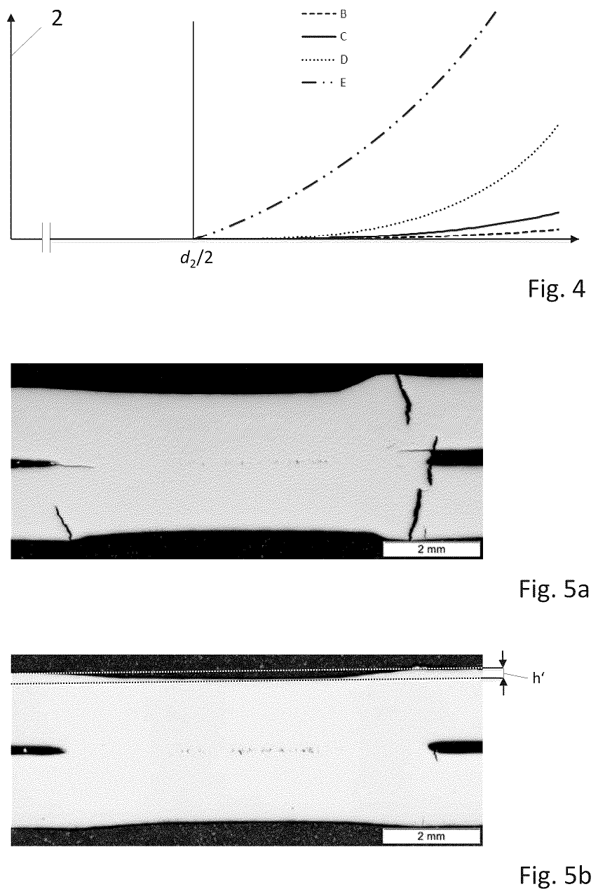

FIG. 4: an enlarged schematic representation of the cap tip area of the cap of the present invention compared to an F1 cap with a flat cap contact surface;

FIG. 5a: a cross-section of a test weld in the optimum welding area with the F1 cap geometry;

FIG. 5b: a cross-section of a test weld in the optimum welding area with cap geometry according to the present invention.

FIG. 1a shows a standard F1 cap known from the prior art in a side view looking perpendicular to a longitudinal axis Z. The cap has an end face with a central cap contact surface with a diameter d₂ and a constant radius of curvature SR₁ as well as a directly adjoining transition area with a constant spherical radius SR₂ between the cap contact surface and the lateral surface. The cap also has an outer diameter d₁ and an overall length l₁.

FIG. 1b shows the F1 cap variant from KR-101988769 B1. standard cap in a side view looking perpendicular to a longitudinal axis Z. The cap also has an end face with a central cap contact surface with a diameter d₂ and a constant radius of curvature SR₁ as well as a directly adjoining transition area with a constant spherical radius SR₂ between the cap contact surface and the outer surface. The cap also has an outer diameter d₁. Furthermore, the cap has a cap tip section 20 with a height h.

In the examples of the prior art, there is always an abrupt transition between ball radius SR₁ and ball radius SR₂.

FIG. 2 shows a spot-welding electrode cap 1 according to the invention which extends along a longitudinal axis 2 and has an end face 3 with a central cap contact surface 4 with a diameter d₂ for contacting the surface of a component to be welded and a transition region 5 between the cap contact surface 4 and the outer surface 6 which is directly radially and tangentially adjacent to the cap contact surface 4 with a transition section 7 of the transition region 5 which is directly radially and tangentially adjacent to the cap contact surface 4, wherein the transition section 7 is convexly curved with a radially outwardly increasing curvature. In the embodiment shown, the cap contact surface 4 and the transition section 7 run along the contour of a common clothoid.

In alternative embodiments, the cap contact surface 4 according to the invention can also be non-curved, i.e. flat, or in other words with an infinite radius of curvature, or the cap contact surface can be convexly curved with a continuous change in the radius of curvature.

In the embodiment shown in FIG. 2, the convex curvature in the transition section 7 directly adjacent to the cap contact surface 4 increases linearly in a radially outward direction, i.e. along the contour of a clothoid. Alternatively, the convex curvature in the area of the transition section 7 can increase continuously radially outwards.

As shown by way of example in FIGS. 3 and 4, in embodiments of the present invention, the described basic shapes of the cap contact surface 4 and the transition section 7 can be combined with one another as desired. For example, FIG. 3 shows the course of a curved cap contact surface with SR₁=50 mm (A) and B (SR₂=8 mm) for the standard F1 cap, C and E are limiting dimensions of the clothoidal course, D course according to the cap according to the invention of the following examples.

Further conceivable combinations are shown in FIG. 4, this time with a flat cap contact surface and B (SR₂=8 mm) for a standard F1 cap, C and E are limiting dimensions of the clothoidal course of the cap tip according to the invention, D course according to the cap according to the invention analogous to FIG. 3.

The coordinates of the clothoids in FIGS. 3 and 4 were determined in a Cartesian coordinate system by the following series developments:

$${X}_{KI} = L ( 1 - {T}^{2} / 10 + {T}^{4} / 216 - {T}^{6} / 9360 )$$

$${Y}_{KI} = L ( T / 3 - {T}^{3} / 42 + {T}^{5} / 1320 - {T}^{7} / 75600 )$$

Here, L is a control variable that describes the length of the clothoid section. L is defined at the start of the transition section as the start of the clothoid and is therefore 0 mm.

T represents the cutting angle of the tangents at the start and end point of the clothoid section in radians and is calculated using the following formula:

$$T = {L}^{2} / ( 2 * {A}^{2} )$$

A is referred to as the parameter of the clothoid and is freely selectable. Clothoids have the property of being similar to each other, so that the clothoid coordinates X and Y are scaled to the sensible range apparent to the skilled person via a scaling constant b. The following formulae show the relationship between the general clothoid coordinates and the transition area of the welding electrode according to the invention. The coordinate system for the clothoid coordinates has its origin in the transition point of the welding contact surface and the transition area and is perpendicular to the tangent of the transition point with the ordinate.

X=b*X_{KI}

Y=b*Y_{KI}

In the example in FIG. 3 and FIG. 4, A=1.22 is defined. L starts with L=0 mm and is increased by 0.01 mm for each additional coordinate pair X_{KI}/Y_{KI}. b is defined for the lower limit dimension at b=9 (marked with dashed lines in FIG. 3 and FIG. 4), as the contact surface becomes too large for b>9. For the upper limit dimension, b=3 (marked with dots in FIG. 3 and FIG. 4), as for b<3 there is no sufficient reduction in the expansion rate and therefore no significant reduction in the LME risk. For the electrode cap of the practical test example, b=5.6 (marked solid in FIG. 3 and FIG. 4). For reference purposes, the radius R=8 mm, which is used for the type F1 welding cap, is also shown in FIG. 3 and FIG. 4 as a two-point line. In FIG. 3, the clothoidal curves were fitted with respect to SR50 of the cap contact surface d2, so that the clothoids all start with an initial radius of curvature of R50 at the transition from d₂/2.

FIGS. 3 and 4 clearly show the smooth transition according to the invention compared to the prior art.

### EXAMPLES

### Manufacturing Example

To carry out practical tests, welding caps according to the invention were turned from CuCr1Zr rods. The caps produced have the cap contact surface and the transition section running along the contour of a common clothoid. The clothoid was manufactured using the approximation method specified herein with the parameters A=1.22 and b=5.6. The length h of the weld cap was 20 mm and the outer diameter d₁ was 16 mm. The cap contact surface de was 5.5 mm.

Furthermore, caps of geometry F1 (F1-16-20-5.5) were turned from the same material for comparison purposes, see DIN EN ISO 5821:2009.

### Practical Test Examples

Two electrolytically galvanized (zinc layer thickness approx. 7 μm) sheets of the DP1200HD from voestalpine with a sheet thickness of 1.6 mm each are pressed with caps with different electrode geometries (type K (according to the invention) & type F1 (comparison)) and different electrode forces (electrode force 3 kN or 4.5 kN) and energized (380 ms or 1140 ms) in order to generate the necessary heat between the two sheets to be welded. The respective amperage results from preliminary tests to determine the optimum welding area for the respective geometries. The welded sheets were then visually inspected for cracks and, after dezincification (with inhibited hydrochloric acid), examined more closely for cracks using a dye penetrant test (‘NORD-TEST’ from HELLING GmbH). These were documented with a DSLR camera (Sony α7s), a 2:1 macro lens (Minolta MC Macro Rokkor-QF, 50 mm, 1:3.5) under UV light. Subsequent cross-sections (separated with Secotom-10, polished with LaboPol-25 and etched with Nital) were photographed with a light microscope (Axio Scope from Zeiss) at 25× magnification, with cracks measured with ImageJ.

The selected parameters are summarized in the following table:

| | | | | | | | | | | | Cracks (dye |
|---|---|---|---|---|---|---|---|---|---|---|---|
| | | | | Application | Welding | | Welding | | Application | Cracks | penetration |
| # | Type | Force | | Force | time | | current | | current | (visual) | test) |
| V1 | F1 | 3 | kN | constant | 380 | ms | 7 | kA | constant | 1 | 7 |
| B1 | K | 3 | kN | constant | 380 | ms | 7.3 | kA | constant | 0 | 0 |
| V2 | F1 | 3 | kN | constant | 1140 | ms | 7 | kA | constant | 9 | 27 |
| B2 | K | 3 | kN | constant | 1140 | ms | 7.3 | kA | constant | 1 | 1 |
| V3 | F1 | 4.5 | kN | constant | 380 | ms | 7.9 | kA | constant | 3 | 4 |
| B3 | K | 4.5 | kN | constant | 380 | ms | 8.3 | kA | constant | 2 | 0 |

The test from V1 or B1 was carried out with a constant force of 3 kN and a constant current of 7 or 7.3 kA (optimum welding current determined from preliminary tests in each case) and a welding time of 380 ms and with a holding time of 300 ms. This results in 1 crack during the visual inspection when welding with the F1 cap and 0 cracks with the cap according to the invention. The dye penetration test shows 7 cracks for the F1 cap and 0 cracks for the cap according to the invention.

The next pair of tests V2 and B2 was carried out with three times the welding time compared to the first pair of tests: Electrode force=3.0 kN, welding time=1140 ms, holding time=300 ms. The required welding current is 7.0 kA for the F1 cap geometry and 7.3 kA for the spot-welding electrode cap of the present invention. The difference in current can be explained on the basis of the spatter limit according to September 1220-2 (2011), but it can be seen that the spot-welding electrode cap according to the invention causes less embrittlement even at higher energy input. FIGS. 5a and 5b show a comparison between the type F1electrode (prior art) and the electrode according to the invention (type K) from the manufacturing example. The visual inspection revealed 9 cracks for the F1 cap and 1 crack for the cap according to the invention. The dye penetrant test revealed 27 cracks for the F1 cap and 1 crack for the cap according to the invention. FIGS. 5a and 5b, each showing a cross-section of a spot weld produced according to this pair of tests, clearly show the difference in the extent and irregularity of plastic deformation between the F1 cap and the cap according to the invention. For example, the slight tilting of the caps in relation to each other can also be clearly identified in the case of the F1 caps in FIG. 5a, while nothing of this kind can be recognized in FIG. 5b.

The third test pair V3 and B3 was carried out with constant force and current application, but with increased values compared to the first test series. Electrode force 4.5 kN and welding current 7.9 kA and 8.3 kA respectively. The visual inspection revealed 3 cracks for the F1 cap and 2 cracks for the cap according to the invention. The dye penetrant test revealed 4 cracks for the F1 cap and 0 cracks for the cap according to the invention.

Thus, it could be shown that the caps according to the invention significantly minimize the risk of LME compared to a welded cap with a sudden change in the radius of curvature at the transition to the transition section.

1-12 (canceled)

13. A spot-welding electrode cap, comprising:
a spot-welding electrode cap body extending along a longitudinal axis and having an end face with a central cap contact surface and a transition section directly radially and tangentially adjoining said central cap contact surface, said transition section being convexly curved with a curvature increasing continuously towards a radial outside.

14. The spot-welding electrode cap according to claim 13, wherein said central cap contact surface is not curved or is convexly curved with a radius of curvature SR₁≥32 mm.

15. The spot-welding electrode cap according to claim 13, wherein said central cap contact surface is convexly curved with a radially outwardly continuously increasing curvature.

16. The spot-welding electrode cap according to claim 13, wherein said central cap contact surface is convexly curved with a radially outwardly linearly increasing curvature.

17. The spot-welding electrode cap according to claim 13, wherein a convex curvature in a region of said transition section increases linearly towards the radial outside.

18. The spot welding electrode cap according to claim 13, wherein said spot welding electrode cap body is rotationally symmetrical with respect to the longitudinal axis.

19. The spot welding electrode cap according to claim 13, wherein said spot welding electrode cap body has an outer diameter d₁ of at least 5 mm.

20. The spot-welding electrode cap according to claim 19, wherein said central cap contact surface extends with its diameter d₂ over 30% to 80% of the outer diameter d₁ of said spot-welding electrode cap body.

21. The spot-welding electrode cap according to claim 19, wherein said transition section extends radially outwards with at least 20% and up to and including 70% of the outer diameter d1 of said spot-welding electrode cap body.

22. The spot welding electrode cap according to claim 13, wherein said spot-welding electrode cap body has a basic shape of an A0, B0, C0, D0, F1or G0 welding electrode cap according to EN ISO 5821:2009 (D).

23. The spot-welding electrode cap according to claim 17, wherein said spot-welding electrode cap body has a basic shape of an F1 cap according to EN ISO 5821:2009 (D).

24. The spot-welding electrode cap according to claim 13, wherein said spot-welding electrode cap body is formed from a material selected from the group consisting of copper and copper alloys.

25. The spot-welding electrode cap according to claim 24, wherein said copper alloys include CuCrZr.

26. The spot welding electrode cap according to claim 19 wherein said spot welding electrode cap body has an outer diameter d₁ of at least 5 mm to 50mm.

27. The spot welding electrode cap according to claim 19 wherein said spot welding electrode cap body has an outer diameter d₁ of at least 10 mm to 25mm.

28. The spot welding electrode cap according to claim 19 wherein said spot welding electrode cap body has an outer diameter d₁ of at least 13 mm to 20mm.

29. The spot welding electrode cap according to claim 13, wherein said spot-welding electrode cap body has a basic shape of an A0, B0, C0, D0, F1 or G0 welding electrode cap according to EN ISO 5821:2009 (D) and with dimensions specified therein.

30. The spot-welding electrode cap according to claim 17, wherein said spot-welding electrode cap body has a basic shape of an F1 cap according to EN ISO 5821:2009 (D) and with dimensions specified therein.
